(19) United States
(12) Patent Application Publication
(10) Pub. No.: US 2007/0120524 A1
(43) Pub. Date: May 31, 2007

(54) BATTERY CHARGER FOR CHARGING DIFFERENT TYPES OF BATTERY PACK

(76) Inventor: King Mo SHUM, Hong Kong (HK)

Correspondence Address: OSTROLENK FABER GERB & SOFFEN, 1180 AVENUE OF THE AMERICAS, NEW YORK, NY, 100368403, US

(21) Appl. No.: 11/548,141

(22) Filed: Oct. 10, 2006

Related U.S. Application Data
(60) Provisional application No. 60/729,686, filed on Oct. 24, 2005.

(51) Int. Cl. H02J 7/00

(52) U.S. Cl. 320/106

(57) ABSTRACT

A battery charger for charging two different types of rechargeable battery pack. A first type of battery pack comprises two electrical terminals and a second type of battery pack comprises a plug and lead type electrical connector. A first socket is provided in a housing for receiving the first type of battery pack, the first socket including contact points for electrical connection of the terminals of the first type of battery pack to the battery charger. A second socket in the housing includes contact points for electrical connection of the plug and lead type connector of the second type of battery pack to the battery charger. The battery charger further comprises AC connectors for connecting the battery charger to an AC electrical power supply outlet. The battery charger has a circuit board having first and second DC electrical circuits for providing power to the battery pack and a switch for activating one of the circuits. When the first type of battery pack is inserted into the first socket, the switch activates the first DC circuit for charging of the first type of battery pack. When no battery pack of the first type is inserted into the first socket the switch deactivates the first DC circuit to enable the second type of battery pack to be charged by connection to the second socket, and the second DC circuit remains active to enable the second type of battery pack to be charged by connection to the second socket.

### REFERENCE TO RELATED APPLICATIONS

This application claims the benefit of the filing date of the U.S. Provisional Patent Application No. 60/729,686 filed Oct. 24, 2006, the disclosures of which are hereby incorporated herein by reference.

### FIELD OF THE INVENTION

The present invention relates to battery chargers and more particularly to battery chargers for recharging battery packs.

### BACKGROUND OF THE INVENTION

Batteries are commonly used to supply power to electrical devices. Batteries offer particular convenience by supplying power to portable electric devices including mobile telephones, radios, CD players and toys, including remotely operable toys. A particular drawback of relying on batteries to supply electrical power is that batteries have a limited useful life during which they are able to supply power. Once a battery is depleted of charge, it may be disposed of and replaced with a new battery. However, since disposal of discharged batteries is harmful to the environment and a wasteful use of resources, rechargeable batteries, such as nickel-cadmium batteries for example, are often used in place of single use batteries. Rechargeable batteries may be discharged and repeatedly charged to prolong their useful life.

Rechargeable batteries require regular charging to maintain a reliable power supply. Once a rechargeable battery is substantially depleted of charge, it is removed from the device to which it supplies electrical power and inserted into a battery charger. Batteries come in a wide range of sizes and shapes to suit a variety of uses. Typically, the size of the battery is relative to the amount of electrical power that the battery is able to supply to an electrically powered device.

Battery packs comprise a plurality of battery cells connected in series with one another. The number of cells within a pack determines the voltage of the battery pack. Battery packs come in a variety of forms including cartridge type battery packs wherein the plurality of battery cells is enclosed within a casing, and shrink-wrapped battery packs wherein the plurality of battery cells is secured together in a desired configuration using shrink wrap film. Such battery packs come in a range of shapes and sizes determined by the number of battery cells included in the battery pack and the manner in which they are connected together. Furthermore, different types of battery packs include different means of contact with the device to which they supply power and a battery charger. Such battery packs are used for supplying electrical power to remote controlled cars and the like.

FIG. 1A is a top view of a shrink-wrapped battery pack 100 comprising in this case, four battery cells 102 secured together by shrink-wrap 104. Contact between the shrink-wrapped battery pack and the device to which power is supplied or a battery charger is provided in the form of a plug 106 and lead 108 type connector 110. FIG. 1B shows the shrink-wrapped battery pack 100 of FIG, 1A as seen from one end. FIG. 2 is a perspective view of a cartridge type battery pack 200 in which the plurality of battery cells is enclosed in a casing 202. Contact between the cartridge battery pack 200 and the device to which power is supplied or a battery charger is provided in the form of terminals 204 on an outer surface of the casing 202.

Whilst battery packs come in a large range of shapes, sizes and configurations, most battery chargers suitable for charging battery packs are configured to receive only a single type of battery pack. That is, typically only a battery pack of a particular type will slot into a socket in the battery charger having terminals to electrically connect to the battery pack to be charged.

Accordingly, there remains a need for a battery charger that solves these and other shortcomings of existing battery chargers.

### SUMMARY OF THE INVENTION

It is an object of the present invention to provide a battery charger which is configured to receive more than one type of battery pack for the purpose of charging the same.

An embodiment of the present invention provides a battery charger for charging two different types of rechargeable battery pack. A first type of battery pack comprises two electrical terminals, and a second type of battery pack comprises a plug and lead type electrical connector. The battery charger comprises a housing. A first socket is provided in the housing for receiving the first type of battery pack, the first socket including contact points for electrical connection of the terminals of the first type of battery pack to the battery charger. A second socket in the housing includes contact points for electrical connection of the plug and lead type connector of the second type of battery pack to the battery charger. The battery charger further comprises AC connectors for connecting the battery charger to an AC electrical power supply outlet. The battery charger also comprises a circuit board having first and second DC electrical circuits for providing power to one or more battery packs and a switch for activating one of the circuits. When the first type of battery pack is inserted into the first socket the switch activates the first DC circuit for charging of the first type of battery pack. When no battery pack of the first type is inserted into the first socket, the first DC circuit is open and no current is delivered through the first DC circuit. The second DC circuit, which enables the second type of battery pack to be charged by connection to the second socket remains active at all times. Current is delivered through the second DC circuit when the second type of battery pack is connected to the second socket.

In one embodiment of the invention, the second type of battery pack is insertable into the first socket but without causing the switch to activate the first DC circuit.

An advantage of an embodiment of the invention is that the battery charger is configured to permit electrical connection to more than one type of battery pack for the purpose of charging the same.

Another advantage of an embodiment of the invention is that a socket of the battery charger is configured to receive more than one type of battery pack.

Another advantage of an embodiment of the invention is that the contact points within the first socket of the battery charger are not part of the circuit when the second type of battery pack is received therein, thereby preventing the second type of battery pack from being short-circuited.

Another advantage of an embodiment of the invention is that both the first type of battery pack and the second type of battery pack may be charged by the battery charger simultaneously.

### BRIEF DESCRIPTION OF THE DRAWINGS

The present information can be more fully understood by reading the subsequent detailed description and examples with reference made to the accompanying drawings in which:

FIG. 1A is a top view of a shrink-wrapped battery pack.

FIG. 1B is the shrink-wrapped battery pack of FIG. 1A as viewed from the side.

FIG. 2 is a perspective view of a cartridge type battery pack.

FIG. 3A is a top view of the battery charger.

FIG. 3B is a front view of the battery charger of FIG. 3A.

FIG. 3C is a side view of the battery charger of FIG. 3A.

FIG. 3D is a back view of the battery charger of FIG. 3A.

FIG. 3E is another side view of the battery charger of FIG. 3A.

FIG. 3F is a bottom view of the battery charger of FIG. 3A.

FIG. 4A is a perspective top view of the battery charger of FIG. 3A.

FIG. 4B is a perspective bottom view of the battery charger of FIG. 3A.

FIG. 5A is a side view of the battery charger of FIG. 3A showing a configuration of internal mechanisms of the battery charger when the first type of battery pack is not inserted into the first socket.

FIG. 5B is a side view of the battery charger of FIG. 3A showing a configuration of internal mechanisms of the battery charger when the first type of battery pack is inserted into the first socket.

FIG. 6 is a perspective side view of the battery charger of FIG. 3A with the first type of battery pack inserted.

FIG. 7 is perspective side view of the battery charger of FIG. 3A with the second type of battery pack inserted.

FIG. 8A is a simple circuit diagram showing the circuit actuated when the second type of battery pack is connected to the battery charger.

FIG. 8B is a simple circuit diagram showing the circuit actuated when the first type of battery pack is connected to the battery charger.

### DETAILED DESCRIPTION OF THE EMBODIMENTS

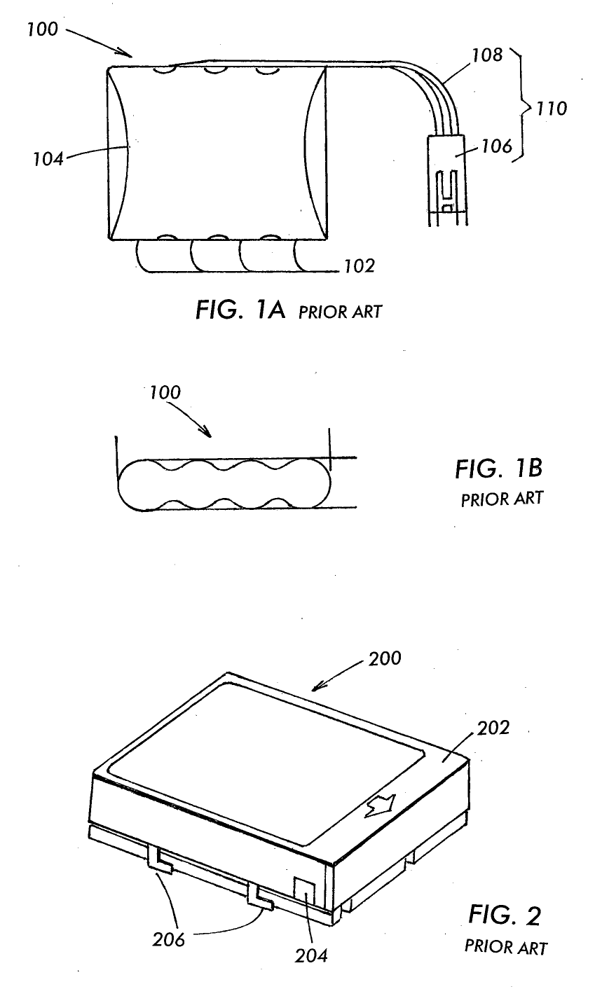

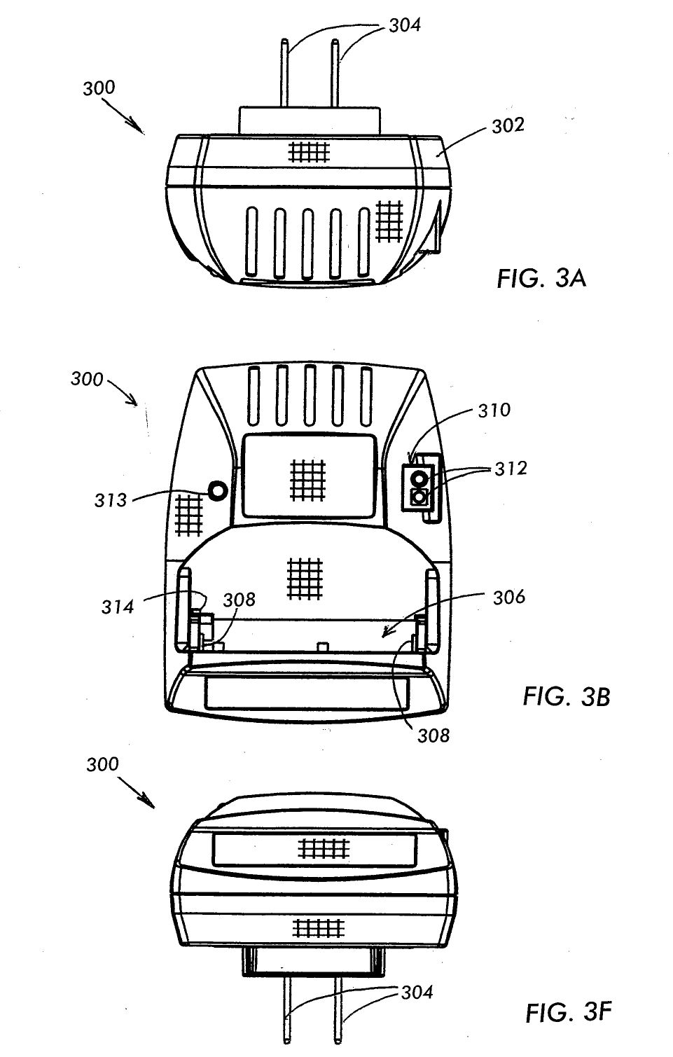

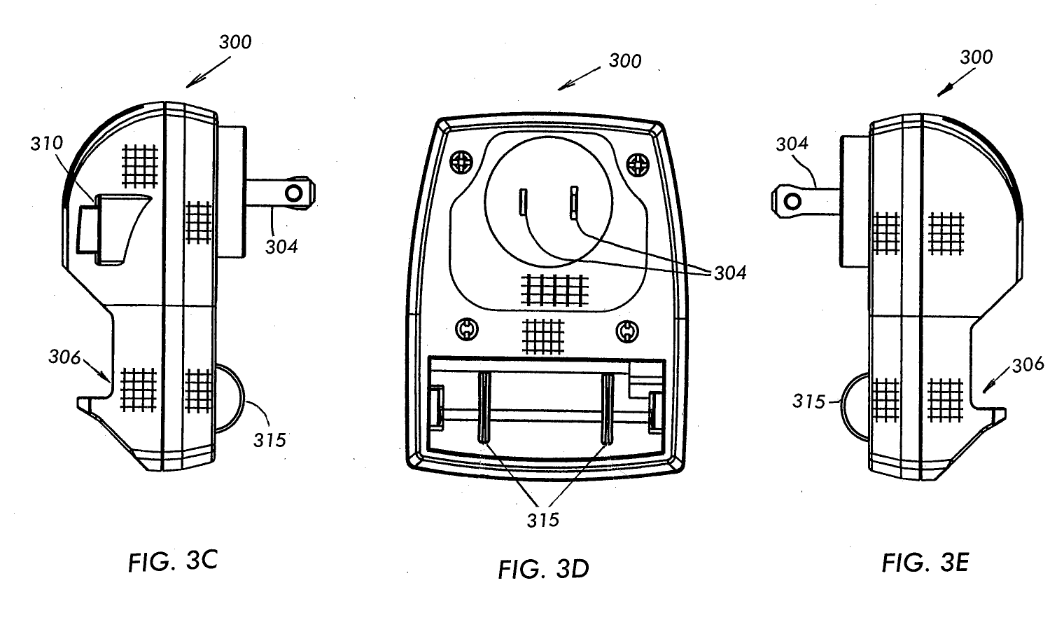

FIG. 3A is a top view of the battery charger 300 of a preferred form of the present invention. The battery charger 300 is suitable for charging two different types of rechargeable battery pack. A first type of battery pack 200 that may be charged by the battery charger 300 comprises two electrical terminals 204 and a switch actuator 206. An example of the first type of battery pack is the cartridge type battery pack (as shown in FIG. 2). A second type of battery pack 100 that may be charged by the battery charger 300 comprises a plug and lead type electrical connector 110. An example of the second type of battery pack 100 is the shrink-wrap type battery pack (as shown in FIGS. 1A and 1B).

The battery charger 300 has a housing 302 to encase the internal mechanisms. The battery charger 300 further comprises AC connectors 304 for connecting the battery charger 300 to an AC electrical power supply outlet.

FIG. 3B is a front view of the battery charger 300 of FIG. 3A. A first socket 306 is provided in the housing 302 for receiving the first type of battery pack 200. The first socket 306 includes contact points 308, which provide for electrical connection of the terminals 204 of the first type of battery pack 200 to the battery charger 300. A second socket 310 is provided in the housing 302, the second socket 310 including contact points 312 for electrical connection of the plug and lead type connector 110 of the second type of battery pack 100 to the battery charger 300. Also shown is a light emitting diode (LED) 313 which emits a signal in the form of light when the battery charger 300 is providing power to at least one battery pack. The battery charger 300 also includes a switch 314 for activating one of the DC electrical circuits for providing power to the battery pack. The switch 314 is actuated when the first type of battery pack 200 is received in the first socket 306. A switch actuator 206 provided on the first type of battery pack 200 serves to engage the switch 314 causing it to move and thereby activating a first DC circuit for charging of the first type of battery pack. When the first DC circuit is activated in this manner, a second DC circuit for charging the second type of battery pack 100 is also active. Therefore, in one embodiment, it is possible to charge both the first type of battery pack 100 and the second type of battery pack 200 simultaneously. However, it is also possible to charge only one of the two types of battery packs at a given time.

The switch actuator 206 may also assist positioning of the battery pack 200 within the battery charger 300 or the electric device to which power is to be supplied. Removal of the first type of battery pack 200 from the first socket 306 causes the switch 314 to return to a non-actuated position. According to one embodiment, regardless of the position of the switch 314, the second DC circuit is activated to enable the second type of battery pack 100 to be charged by connection to the second socket 312.

FIG. 3C is a side view of the battery charger 300 of FIG. 3A showing the first and second sockets 306,310 and the AC connectors 304 as viewed from the side. In one embodiment, one or more supports 315 may be provided to rest against all wall when the AC connectors 304 are connected to an electrical wall outlet. The supports may be integrated into the housing 302 of the battery charger. However, the supports 315 are not necessary and these or other structures may be included or omitted to suit needs of the use and design of the battery charger 300.

FIG. 3D is a back view of the battery charger 300 of FIG. 3A showing the AC connectors 304 and the supports 315 as viewed from the back.

FIG. 3E is another side view of the battery charger 300 of FIG. 3A showing the first socket 306, the AC connectors 304, and the supports 315 as viewed from the side.

FIG. 3F is a bottom view of the battery charger 300 of FIG. 3A showing the AC connectors 304 as viewed from the bottom.

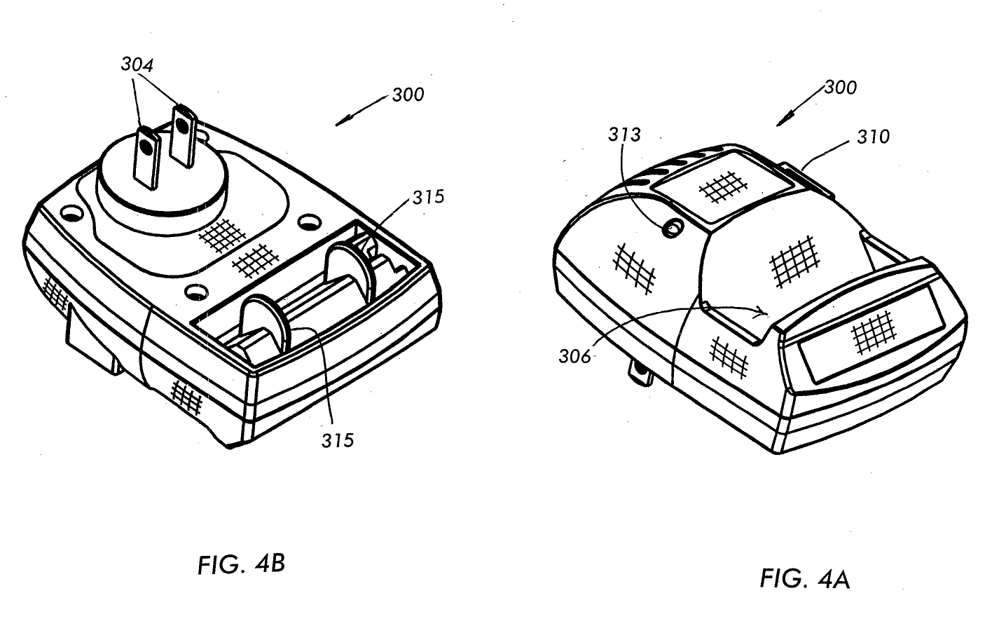

FIG. 4A is a perspective top view of the battery charger 300 of FIG. 3A. The first and second sockets 306, 310, which provide a means of connection of the battery packs 100,200 to the battery charger 300, are shown. The LED 313 is also shown.

FIG. 4B is a perspective bottom view of the battery charger 300 of FIG. 3A. The AC connectors 304, which provide means of connection to an AC power source, and the supports 315 are shown.

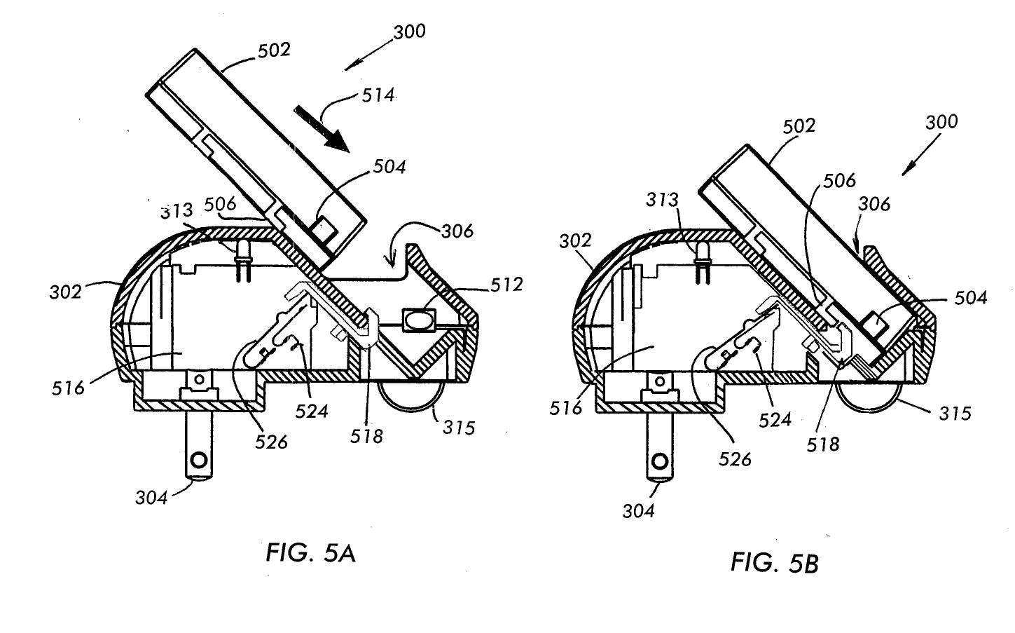

FIG. 5A is a side view of the battery charger 300 of FIG. 3A showing a configuration of internal mechanisms of the battery charger 300 when the battery pack 502, of the first type or the cartridge type, is not inserted into the socket 306. The battery charger 300 is configured to receive two different types of battery pack for charging. One type of battery pack 502 suitable for use with the battery charger 300 of the present invention comprises two electrical terminals 504, one on each side of the battery pack 502 (only one of the pair shown in FIG. 5A) and a switch actuator 506. A second type of battery pack 100 (see FIG. 1A and 1B) comprises a plug and lead type electrical connector 110. The battery charger 300 has a housing 302. The housing 302 comprises a first socket 306 in the housing for receiving the first type of battery pack 502, the first socket 306 including two contact points 512 (only one shown in FIG. 5A) for electrical connection of the terminals 504 of the first type of battery pack 502 to the battery charger 300. The battery pack 502 is inserted into the first socket 306 in the direction generally indicated by arrow 514.

The battery charger 300 comprises AC connectors 304 for connecting the battery charger 300 to an AC electrical power supply outlet. The AC connectors 304 may take the form of a conventional plug to be received in a socket for connection to an AC power supply.

The battery charger 300 further incudes a circuit board 516 having alternative first and second DC electrical circuits for providing power to the battery pack 502. A switch 518 is provided for activating the first DC circuit. The circuits include two conductive metal plates, first metal plate 524 and second metal plate 526, arranged on the circuit board 516 such that connections between the first and second metal plates 524, 526 can be opened and closed, thereby opening and closing the first DC circuit.

The configuration of a circuit board 516 of the battery charger 300 provides that, when the switch 518 is in a non-actuated position, as shown in FIG. 5A, the first and second metal plates 524, 526 are not in contact, and the first DC circuit is opened. In one embodiment, when the switch 518 is in the non-actuated position, the second DC circuit is closed and activated to enable the second type of battery pack 100 to be charged by connection to the second socket 310 of the battery charger 300.

As described previously, the switch 518 is actuated by engagement with the switch actuator 506 provided on the first type of battery pack 502. In FIG. 5A the battery pack 502 having the switch actuator 506 has not yet been inserted into the first socket 306 of the battery charger 300. Therefore, the first and second metal plates 524, 526 arranged on the circuit board 516 are not in contact. Therefore, the first DC circuit for charging the first type of battery pack 502 is not activated and only the second DC circuit for charging the second type of battery pack 100 is activated.

Referring to FIG. 5B, a side view of the same battery charger 300 with the first type of battery pack 502 inserted in the first socket 510 for charging. As in FIG. 5A, the internal mechanisms are shown. In the illustrated embodiment, the switch actuator 506 provided on the first type of battery pack 502 takes the form of an L-shaped member. However, the switch actuator 506 may take any other suitable form that is configured to actuate the switch 518.

FIG. 5B shows more clearly how the switch 518 is actuated when the first socket 306 receives the first type of battery pack 502. The L-shaped member 506 engages the switch 518 causing it to move generally in the direction of the arrow 514 (shown in FIG. 5A) to bring conductive metal plates 524 and 526 into contact with one another. This movement causes the first DC circuit for charging of the first type of battery pack 502 to be activated.

Conversely, removal of the first type of battery pack 502 from the first socket 306 causes the switch 518 to return to a non-actuated position. In one form of the invention, the switch 518 may be urged to return to the non-actuated position by a biasing means, such as a spring member (not shown). In another embodiment, the first metal plate 524 is acts as a spring such that an end of the first metal plate 524 contacting the switch 518 exerts a force in a direction opposite to the direction of the arrow 514 (shown in FIG. 5A). The amount of force exerted by the first metal plate 524 on the switch 518 may be any amount suitable to return the switch 518 to the non-actuated position.

The configuration of elements on the circuit board 516 provide that when the switch 518 has been moved to the actuated position by engagement by a switch actuator 506 provided on the first type of battery pack 502, the first and second metal plates 524, 526 are brought into contact with each another. This movement causes the first DC circuit to be activate do provide for charging of the first type of battery pack 502 inserted in the first socket 306 of the battery charger 300.

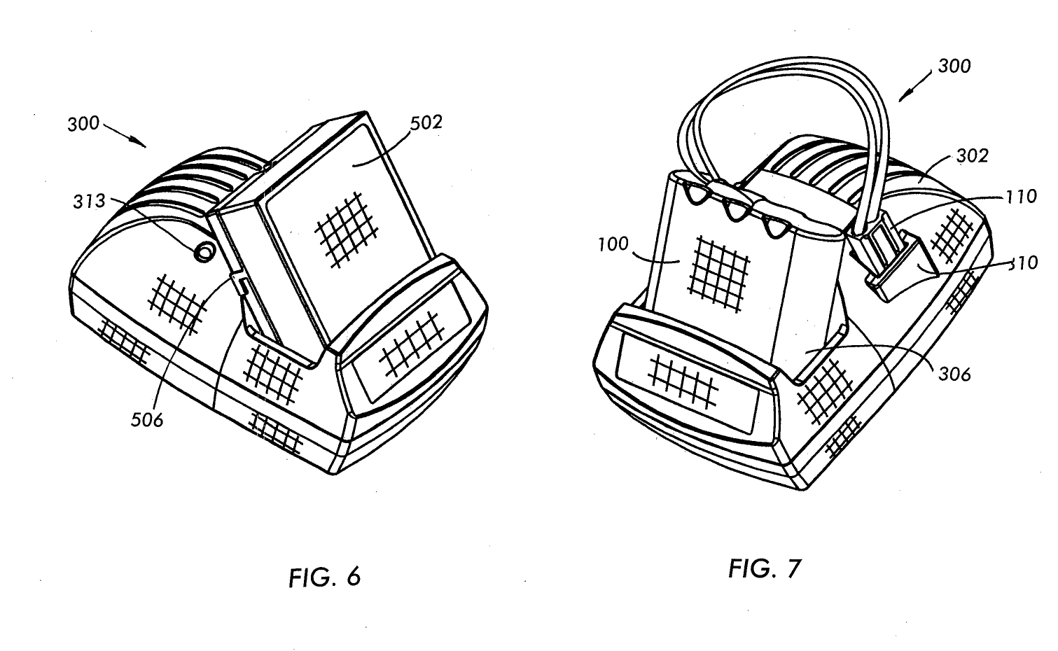

FIG. 6 is a perspective side view of the battery charger 300 of FIG. 3A with the first type of battery pack 502 inserted into the first socket 306. Also shown is a light emitting diode (LED) 313 which emits light when the battery charger 300 is providing power to the battery pack 502.

When the first type of battery pack 502 is inserted into the first socket 306 and the switch actuator 506 triggers activation of the first DC circuit for charging the first type of battery pack 502, the first DC circuit forms a closed circuit through the first type of battery pack 502 via the contact points 512 in the first socket 306 and the terminals 504 on the battery pack 502.

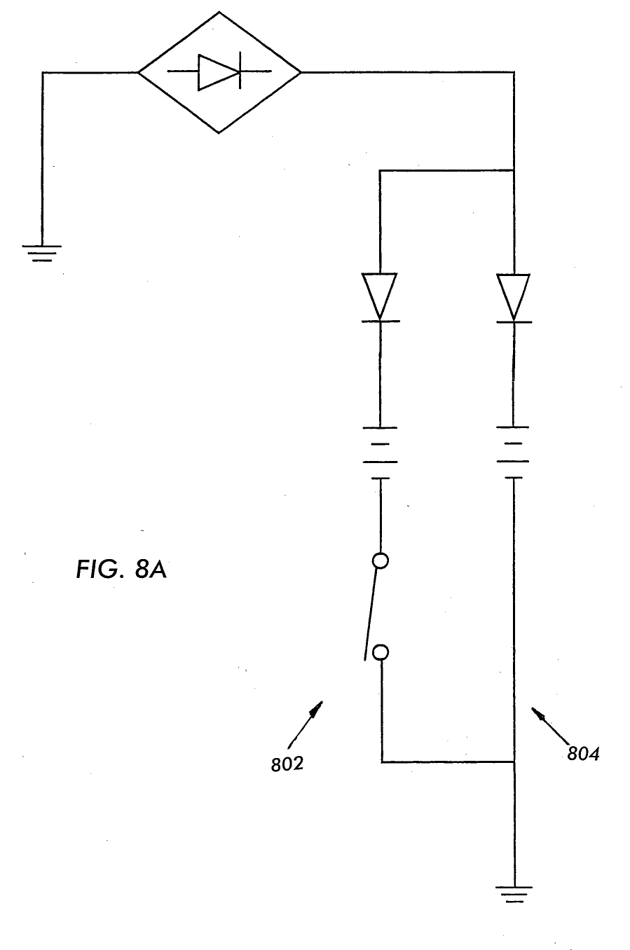

FIG. 7 is perspective side view of the battery charger 300 of FIG. 3A with the second type of battery pack 100 inserted. This second type of battery pack 100 includes a plug and lead type connector 110 which is inserted into the second socket 310 in the housing 302. The second socket 310 includes contact points for electrical connection of the plug and lead type connector 110 to the battery charger 300.

Furthermore, in one embodiment of the invention, the second type of battery pack 100 is configured to be received in the first socket 306 without actuating the switch 518 (shown in FIG. 5A and 5B). This provides a convenient means of storing the second type of battery pack 100 during the charging operation. In another embodiment, the second type of battery pack 100 may be connected to the battery charger 300 by the plug and lead type connector 110 being connected to the second socket 310 but not located in the first socket 306. Simultaneously, the first type of battery 502 may be located in the first socket 306. Accordingly, it is possible to charge both the first type of battery 502 and the second type of battery 100 simultaneously.

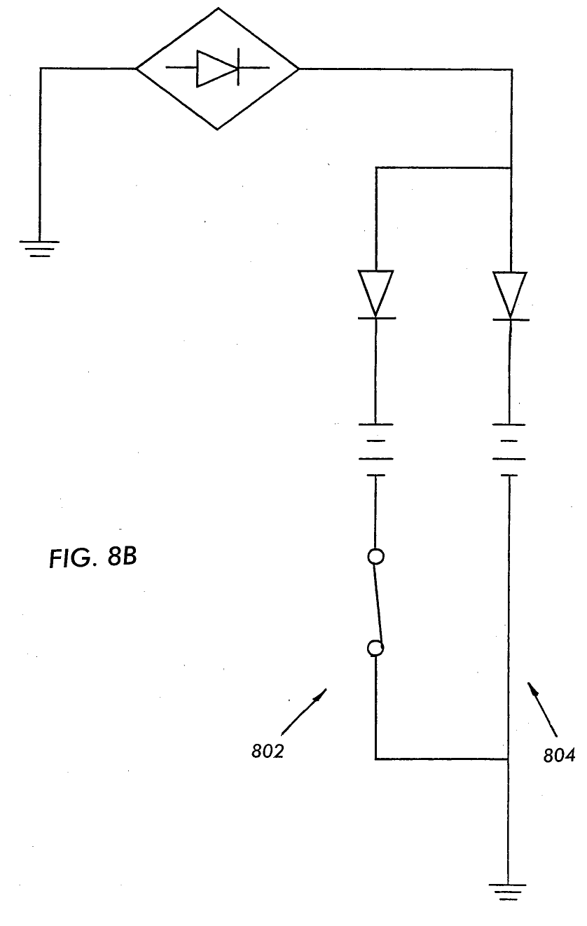

FIG. 8A is a simple circuit diagram showing the circuit actuated when the first DC circuit 802 is not actuated; that is, only the second DC circuit 804 is activated. The second type of battery pack 100 may be connected to the battery charger 300 when the switch 518 is in the non-actuated position (see FIG. 5A).

FIG. 8B is a simple circuit showing the circuit actuated when the switch 518 (see FIG. 5A) is actuated by insertion of the first type of battery pack 502 into the first socket 306 of the battery charger 300. Accordingly, it can be seen that both the first DC circuit 802 and the second DC circuit 804 are actuated when the first type of battery pack 502 is inserted into the first socket 306 of the battery charger 300.

It is an advantage of the present invention that causing the first DC circuit to be closed will not cause the second DC circuit to be open. Accordingly, two circuits may be closed simultaneously and two different types of battery packs may be charged simultaneously.

One particular problem relating to the charging of the shrink wrapped type battery packs 100 described earlier, is that when certain portions of the shrink wrap 104 are damaged, that is, a portion of the shrink wrap 104 that covers an area of a battery cell or cells 102 that may come into contact with a conducting body at some stage, the battery pack 100 may be short-circuited and burnt out. This problem may arise for instance, if a shrink wrap type battery pack 100 were inserted into the first socket 306 of the battery charger 300 of the present invention, and it was not possible to inactivate the first DC circuit for charging the first type of battery pack 200 (FIG. 2) wherein a closed circuit is formed through the first type of battery pack 200 via the contact points 308 (FIG. 3B) in the first socket 306 and the terminals 204 on the battery pack 200. Since the circuit passing through the contact points 308 in the first socket 306 is open and inactive when a shrink wrap type battery 100 pack lacking a switch actuator 206 is inserted into the first socket 306 of the battery charger 300, the short circuiting problem is negated by the battery charger 300 of the present invention.

Whilst an embodiment of the present invention has been illustrated here in detail, it should be apparent that modifications and adaptations to these embodiments may occur to one skilled in the art without departing from the scope of the invention as described.

What is claimed is:

1. A battery charger for charging two different types of rechargeable battery pack, a first battery pack type comprising two electrical terminals, a second battery pack type comprising a plug and lead type electrical connector, the battery charger comprising:
a housing;
a first socket in the housing for receiving the first type of battery pack, the first socket including contact points for electrical connection of the terminals of the first type of battery pack to the battery charger;
a second socket in the housing, the second socket including contact points for electrical connection of the plug and lead type connector of the second type of battery pack to the battery charger;
AC connectors for connecting the battery charger to an AC electrical power supply outlet;
a circuit board having alternative first and second DC electrical circuits for providing power to the battery pack;
a switch for activating one or other of the circuits; and
wherein, when the first type of battery pack is inserted into the first socket, the switch activates the first DC circuit for charging of the first type of battery pack, and when no battery pack of the first type is inserted into the first socket, the switch deactivates the first DC circuit, and wherein the second DC circuit remains active to enable the second type of battery pack to be charged by connection to the second socket.

2. A battery charger according to claim 1, wherein the second type of battery pack is insertable into the first socket without causing the switch to activate the first DC circuit, so that only the second DC circuit is active.

3. A battery charger according to claim 2, wherein the contact points in the first socket do not form a part of the second DC circuit when the second type of battery pack is received therein.

4. A battery charger according to claim 1, wherein the first type of battery pack includes a switch actuator which actuates the switch when the first type of battery pack is inserted into the first socket.

5. A battery charger according to claim 4, wherein the switch actuator is an L-shaped member protruding from a side of the first battery pack type.

6. A battery charger according to claim 4, wherein when the first type of battery pack is removed from the first socket, a biasing means urges the switch to move to a position at which the first DC circuit is deactivated.

7. A battery charger according to claim 1 wherein the first DC electrical circuit is open when no battery pack of the first type is inserted into the first socket.
